(19) United States
(12) Patent Application Publication
(10) Pub. No.: US 2023/0404119 A1
(43) Pub. Date: Dec. 21, 2023

(54) LEGUME-DERIVED FRACTIONS AND USES THEREOF

(71) Applicant: Innovopro Ltd., Raanana (IL)

(72) Inventors: Nitzan Natani Ben Chaim, Ashdod (IL); Svetlana Zivanovic, Thompson's Station, TN (US)

(21) Appl. No.: 18/247,186

(22) PCT Filed: Sep. 29, 2021
(86) PCT No.: PCT/IL2021/051174

§ 371 Date: Mar. 29, 2023

(30) Foreign Application Priority Data
Sep. 29, 2020 (IL) 277654

(51) Int. Cl. A23L 15/00; A23L 11/00; A23L 29/30; A23J 1/14; A23G 3/48

(52) U.S. Cl. CPC A23L 15/35; A23L 11/00; A23L 29/30; A23J 1/14; A23G 3/48

(57) ABSTRACT

The present disclosure provides a legume-derived food ingredient, the food ingredient comprising sugar, legume starch and legume proteins, including at most 0.8% legume starch and is characterized by a solid content of at most 60%, a process for the preparation of the food ingredient and uses thereof, for example as a foaming agent.

### TECHNOLOGICAL FIELD

The present disclosure relates to legume-derived food ingredients and specifically to chickpea-derived food ingredients and uses thereof for example as foaming agents.

### BACKGROUND ART

References considered to be relevant as background to the presently disclosed subject matter are listed below:
[1] US Patent Application No. 2016/309732
[2] International patent application publication No. 2020/086453
[3] Mustafa R. et al. International Journal of Food Science and Technology 2018, 53; 2247-2255.
[4] International patent application publication No. 2018/122607.

Acknowledgement of the above references herein is not to be inferred as meaning that these are in any way relevant to the patentability of the presently disclosed subject matter.

### BACKGROUND

Legume-derived food products are considered as a growing portion of the food industry as they provide a healthy food alternative. Non-dairy substitutes from legumes were previously described [1, 2].

Aquafaba, the legume brine, is an example of a vegetarian egg replacement which is used to prepare a variety of food products, including, inter alia, baked and non-baked goods [3].

Preparations of legume proteins and uses thereof were previously described [4].

### GENERAL DESCRIPTION

The present disclosure is based on the surprising findings that aqueous (water) fraction obtained during a process of protein isolation from legume can be used in the preparation of a legume-derived food ingredient that has properties allowing it to be used, inter alia, as a foaming agent.

It has also been surprisingly found that the legume-derived food ingredient comprises low amounts of legume starch and at times is essentially free from legume starch, which, among other characteristics, distinguish it from aquafaba.

These properties render the legume-derived food ingredient a valuable ingredient in the food industry, to be used, inter alia, as a foaming agent and/or as an egg white replacer. Without being limited thereto, the legume derived food ingredient disclosed herein can be of particular use in non-baked as well as in bakery and pastry food products.

Based on the above finding, the present disclosure provides, in accordance with a first of its aspects a legume-derived food ingredient. The food ingredient includes sugar, legume starch and legume proteins. The food ingredient comprises at most 0.8% legume starch out of the total weight of the food ingredient; and characterized by a solid content of at most 60%.

The present disclosure also provides in accordance with yet some other aspects a process for the preparation of a legume-derived food ingredient, the process comprising providing an aqueous legume derived fraction and treating the legume derived fraction to obtain a legume-derived food ingredient characterized by a solid content of at most 60%.

The present disclosure also provides in accordance with yet some further aspects a process for the preparation of a legume-derived food ingredient, the process comprises:
mixing legume flour with a basic pH adjusting agent to obtain a basic slurry with a basic pH;
isolating a first liquid fraction from said basic slurry;
treating the first liquid fraction with an acidic pH adjusting agent to obtain an acidic slurry;
isolating a second liquid fraction from said acidic slurry, and
treating the second liquid fraction to obtain a food ingredient characterized by a solid content of at most 60%.

The present disclosure also provides in accordance with some other aspects, a food product comprising a legume-derived food ingredient as described herein.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A and 1B are bar graph showing the foaming capacity and foaming stability 30 minutes after whipping, respectively, of exemplary legume-derived food ingredients; black bars—pH 4.3, vertical bar (12.5%)—pH 6.44, horizontal bar (33.6%)—pH 6.5 and wavy bar (37%)—pH 5.35, open bar AF (Aquafaba).

FIG. 2 is an exemplary image of an SDS-PAGE of an exemplary legume-derived food ingredient at various dilutions; marker—size marker, 1-food ingredient (“SF”) dilution ×10; 2-AF dilution ×10; 3-SF dilution ×8.5; 4-AF dilution ×8.5; 5-AF dilution ×7; 6-SF dilution ×7; 7-AF dilution ×7; 8-SF dilution ×5; 9-AF dilution ×5.

### DETAILED DESCRIPTION OF EMBODIMENTS

Non-dairy, vegan plant foaming/whipping agents, such as aquafaba, have become popular as egg replacement for bakers and caterers.

As noted above, the present disclosure is based on the findings that a legume-derived water fraction which may be isolated, for example, during legume protein extraction/separation, and treated by concentration, forms a stable foam. When compared to aquafaba, which is an aqueous solution in which legumes are cooked, the legume-derived food ingredient of the present disclosure comprises significantly low amounts of legume starch and similar amounts of sugar and legume proteins. Surprisingly, the legume-derived food ingredient, forms a foam that is as stable or more stable as a foam prepared from both aquafaba and egg whites.

Hence, the legume derived food ingredient forms a foam and can be used as a foaming agent.

In some embodiments, the legume-derived food ingredient is characterized by a high solid content.

Hence, the present disclosure provides a legume-derived food ingredient, wherein the food ingredient comprises at most 0.8% legume starch and characterized by a solid content of at most about 80%.

In some embodiments, the legume-derived food ingredient is characterized by a solid content of at most about 75%, at times at most about 70%, at times at most about 65% and at times even at most about 60%.

In accordance with some other aspects, the present disclosure provides a legume-derived food ingredient, wherein the food ingredient comprises at most 0.8% legume starch; and characterized by a solid content of at most about 60%

In accordance with some further aspects, the present disclosure provides a legume-derived food ingredient comprising sugar, legume protein and legume starch, wherein the food ingredient comprises at most 0.8% legume starch; and characterized by a solid content of at most about 60%.

In accordance with another aspect, the present disclosure provides a process for the preparation of the legume-derived food ingredient, the process comprises providing a legume derived aqueous fraction and treating the legume derived aqueous fraction to obtain a food ingredient characterized by solid content of about 60%.

In accordance with yet another aspect, the present disclosure provides a process for the preparation of the legume-derived food ingredient, the process comprises:
(i) mixing legume flour with a basic pH adjusting agent to obtain a basic slurry with a basic pH;
(ii) isolating a first liquid fraction from the basic slurry;
(iii) treating the first liquid fraction with an acidic pH adjusting agent to obtain an acidic slurry,
(iv) isolating a second liquid fraction from the acidic slurry, the second liquid fraction comprising the legume-derived food ingredient; and
(v) treating the first liquid fraction and/or the second liquid fraction to obtain a food ingredient characterized by a solid content of at most 60%.

In the following disclosure, when referring to legume-derived food ingredient it is to be understood as referring to process preparing the same and to food products comprising the same. Thus, whenever providing a feature with reference to the legume-derived food ingredient, it is to be understood as defining the same feature with respect to the food product and the processes, mutatis mutandis.

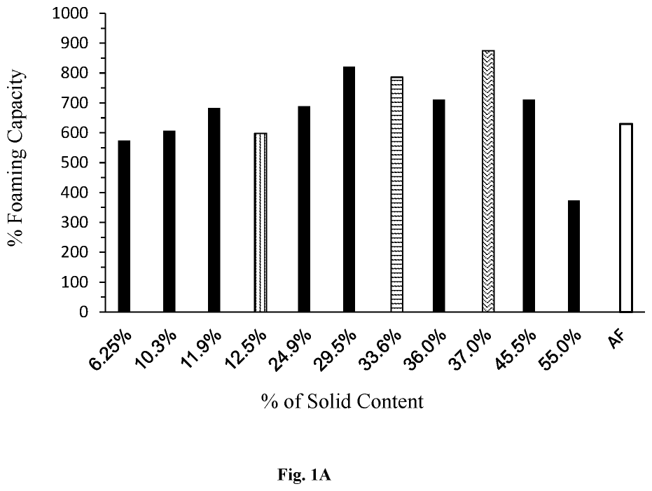

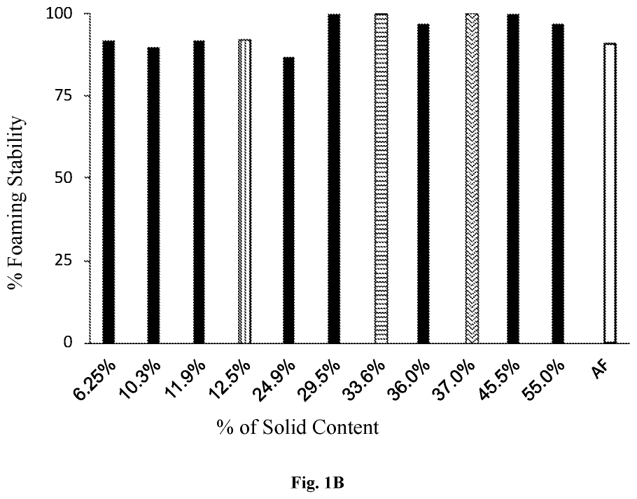

As shown in Tables 1A, 1B, FIGS. 1A and 1B, the legume derived food ingredient (also denoted herein as food ingredient) had a foaming capacity and foaming stability that were comparable or even better than aquafaba. In addition, as shown herein, the food ingredient including solid content of at least 5%, at times of at least 6% formed a foam that was stable for at least 30 minutes.

As used herein the term “solid content” also denoted at times as “total solid” refers to dry matter that remains after water is removed from a sample and in connection with the present disclosure from the legume derived aqueous fraction.

As described herein below, the legume derived aqueous fraction (also denoted herein as aqueous fraction) was processed to obtain legume derived food ingredients, each having a different % of solid content. It is of note that reference to a legume derived food ingredient encompasses such food ingredient with a % of solid content as described and claimed herein.

The solid content can be measured by any known method in the art. For example, the % of solid content can be determined by using a moisture analyzer. As shown in the Examples below, an exemplary method of measuring the % of solid content is by using the MRC moisture analyzer.

Unless otherwise stated, characterization of the legume derived food ingredient was determined on dry matter and hence, characterization refers to % w/w of dry matter (at times referred herein as dry based (db) or dry weight (dw)) out of the total weight of the food ingredient.

In some embodiments, the legume-derived food ingredient is characterized by a solid content of at most about 80%, at times at most about 75%, at times at most about 70%, at times at most about 65%, at times at most about 60%, at times at most about 59%, at times at most about 57%, at times at most about 55%, at times at most about 53%, at times at most about 51%, at times at most about 50%, at times at most about 48%, at times at most about 46%, at times at most about 45%.

In some embodiments, the legume-derived food ingredient is characterized by a solid content of at most about 59%, at times at most about 57%, at times at most about 55%.

In some embodiments, the legume-derived food ingredient is characterized by a solid content of at most about 54%, at times at most about 53%, at times at most about 52%, at times at most about 51%, at times at most about 50%, at times at most about 48%, at times at most about 46%, at times at most about 45%.

In some embodiments, the legume-derived food ingredient is characterized by a solid content of about 45%, at times at most about 44%, at times at most about 42%, at times at most about 40%, at times at most about 38%, at times at most about 37%, at times at most about 36%, at times at most about 34%, at times at most about 33%, at times at most about 31%, at times at most about 29%, at times at most about 27%, at times at most about 25%, at times at most about 24%, at times at most about 20%, at times at most about 15%, at times at most about 10%, at times at most about 6%.

In some embodiments, the legume-derived food ingredient is characterized by a solid content of at least about 5%, at times at least about 6%, at times at least about 8%, at times at least about 10%, at times at least about 12%, at times at least about 14%, at times at least about 16%, at times at least about 18%, at times at least about 20%, at times at least about 22%, at times at least about 24%, at times at least about 26%, at times at least about 28%, at times at least about 29%, at times at least about 30%, at times at least about 33%, at times at least about 35%, at times at least about 36%, at times at least about 37%, at times at least about 40%, at times at least about 42%, at times at least about 45%.

In some embodiments, the legume-derived food ingredient is characterized by a solid content of at least about 29%, at times at least about 30%, at times at least about 33%, at times at least about 35%, at times at least about 36%, at times at least about 37%, at times at least about 40%, at times at least about 42%, at times at least about 45%, at times at least about 47%, at times at least about 50%, at times at least about 52%, at times at least about 55%, at times at least about 57%.

In some embodiments, the legume-derived food ingredient is characterized by a solid content of at least about 47%, at times at least about 50%, at times at least about 52%, at times at least about 55%, at times at least about 57%.

In some embodiments, the legume-derived food ingredient is characterized by a solid content of between about 5% and about 60%.

In some embodiments, the legume-derived food ingredient is characterized by a solid content of between about 5% and about 59%, at times between about 5% and about 57%, at times between about 5% and about 55%, at times between about 5% and about 47%, at times between about 5% and about 45%, at times between about 5% and about 37%, at times between about 5% and about 36%, at times between about 5% and about 33%, at times between about 5% and about 29%, at times between about 5% and about 24%, at times between about 5% and about 12%, at times between about 5% and about 10%.

In some embodiments, the legume-derived food ingredient is characterized by a solid content of between about 6% and about 59%, at times between about 6% and about 57%.

In some embodiments, the legume-derived food ingredient is characterized by a solid content of between about 6% and about 55%, at times between about 6% and about 47%, at times between about 6% and about 45%, at times between about 6% and about 37%, at times between about 6% and about 36%, at times between about 6% and about 33%, at times between about 6% and about 29%, at times between about 6% and about 24%, at times between about 6% and about 12%, at times between about 6% and about 10%.

In some embodiments, the legume-derived food ingredient is characterized by a solid content of between about 10% and about 59%, at times between about 10% and about 57%.

In some embodiments, the legume-derived food ingredient is characterized by a solid content of between about 10% and about 55%, at times between about 10% and about 47%, at times between about 10% and about 45%, at times between about 10% and about 37%, at times between about 10% and about 36%, at times between about 10% and about 33%, at times between about 10% and about 29%, at times between about 10% and about 24%, at times between about 10% and about 12%.

In some embodiments, the legume-derived food ingredient is characterized by a solid content of between about 12% and about 59%, at times between about 12% and about 57%.

In some embodiments, the legume-derived food ingredient is characterized by a solid content of between about 12% and about 55%, at times between about 12% and about 47%, at times between about 12% and about 45%, at times between about 12% and about 37%, at times between about 12% and about 36%, at times between about 12% and about 33%, at times between about 12% and about 29%, at times between about 12% and about 24%.

In some embodiments, the legume-derived food ingredient is characterized by a solid content of between about 15% and about 59%, at times between about 15% and about 57%, at times between about 15% and about 55%, at times between about 15% and about 47%, at times between about 15% and about 45%, at times between about 15% and about 37%, at times between about 15% and about 36%, at times between about 15% and about 33%, at times between about 15% and about 29%, at times between about 15% and about 24%.

In some embodiments, the legume-derived food ingredient is characterized by a solid content of between about 20% and about 59%, at times between about 20% and about 57%, at times between about 20% and about 55%, at times between about 20% and about 47%, at times between about 20% and about 45%, at times between about 20% and about 37%, at times between about 20% and about 36%, at times between about 20% and about 33%, at times between about 20% and about 29%, at times between about 20% and about 24%.

In some embodiments, the legume-derived food ingredient is characterized by a solid content of between about 24% and about 59%, at times between about 24% and about 57%.

In some embodiments, the legume-derived food ingredient is characterized by a solid content of between about 24% and about 55%, at times between about 24% and about 47%, at times between about 24% and about 45%, at times between about 24% and about 37%, at times between about 24% and about 36%, at times between about 24% and about 33%, at times between about 24% and about 29%.

In some embodiments, the legume-derived food ingredient is characterized by a solid content of between about 26% and about 59%, at times between about 26% and about 57%, at times between about 26% and about 55%, at times between about 26% and about 47%, at times between about 26% and about 45%, at times between about 26% and about 37%, at times between about 24% and about 36%, at times between about 24% and about 33%, at times between about 24% and about 29%.

In some embodiments, the legume-derived food ingredient is characterized by a solid content of between about 29% and about 59%, at times between about 29% and about 57%.

In some embodiments, the legume-derived fraction is characterized by a solid content of between about 29% and about 55%, at times between about 29% and about 47%, at times between about 29% and about 45%, at times between about 29% and about 37%, at times between about 29% and about 36%, at times between about 29% and about 33%.

In some embodiments, the legume-derived food ingredient is characterized by a solid content of about 5%, at times about 6%, at times about 8%, at times about 10%, at times about 12%, at times about 14%, at times about 16%, at times about 18%, at times about 20%, at times about 22%, at times about 24%, at times about 26%, at times about 28%, at times about 29%, at times about 30%, at times about 33%, at times about 35%, at times about 36%, at times about 37%, at times about 40%, at times about 42%, at times about 45%, at times about 47%, at times about 50%, at times about 52%, at times about 55%, at times about 57%.

In some embodiments, the legume-derived food ingredient is characterized by a solid content of about 6%. In some embodiments, the legume-derived food ingredient is characterized by a solid content of about 10%. In some embodiments, the legume-derived food ingredient is characterized by a solid content of about 12%. In some embodiments, the legume-derived food ingredient is characterized by a solid content of about 24%. In some embodiments, the legume-derived food ingredient is characterized by a solid content of about 29%. In some embodiments, the legume-derived food ingredient is characterized by a solid content of about 33%. In some embodiments, the legume-derived food ingredient is characterized by a solid content of about 36%. In some embodiments, the legume-derived food ingredient is characterized by a solid content of about 37%. In some embodiments, the legume-derived food ingredient is characterized by a solid content of about 45%.

The legume-derived food ingredient is further characterized by the density. The density can be determined and calculated by any known method in the art. For example, the density of the legume-derived fraction can be determined by measuring the volume of a sample in a measuring cup vs. its weight in calibrated analytical weight

In some embodiments, the density of the legume-derived food ingredient is at least about 1.01 g/cm³, at least about 1.06 g/cm³, at least about 1.08 g/cm³, at least about 1.14 g/cm³, at least about 1.15 g/cm³, at least about 1.16 g/cm³, at least about 1.18 g/cm³, at times at least about 1.2 g/cm³, at times at least about 1.22 g/cm³.

In some embodiments, the density of the legume-derived food ingredient is at least about 1.01 g/cm³, at times at least about 1.3 g/cm³, at times at least about 1.01 g/cm³, at times at least about 1.22 g/cm³.

In some embodiments, the density of the legume-derived food ingredient is about 1.01 g/cm³, about 1.06 g/cm³, about 1.08 g/cm³, about 1.14 g/cm³, about 1.15 g/cm³, a about 1.16 g/cm³, about 1.18 g/cm³, about 1.2 g/cm³, at times about 1.22 g/cm³.

The pH of the legume derived food ingredient can be acidic, basic or neutral.

In some embodiments, the pH of the legume derived food ingredient is acidic.

In some other embodiments, the pH of the legume derived food ingredient is between about 2 and about 7, at times between about 3 and about 7, at times between about 4 and about 7, at times between about 4 and about 6.5.

In some embodiments, the pH of the legume derived food ingredient is about 4, at times about 4.3, at times about 4.5, at times about 5, at times about 5.5, at times at least about 6, at time about 6.5.

In some embodiments, the pH of the legume derived food ingredient is basic.

In some other embodiments, the pH of the legume derived food ingredient is between about 7 and about 9, at times between about 7 and about 8, at times between about 8 and about 9.

As described herein, the legume-derived food ingredient comprises low amounts of starch, specifically legume starch and at times is essentially free of legume starch.

The legume starch refers to a polysaccharide (polymeric carbohydrate) found in legume such as chickpea and containing numerous glucose units joined by glycosidic bonds. Generally, starch consists of two types of molecules: linear and helical amylose and branched amylopectin, both are able to produce monosaccharides and disaccharides.

As detailed herein, the food ingredient comprises up to about 0.8% legume starch. It is of note that unless otherwise indicated, reference to % of legume starch is made to the % as measured as dry matter (dry basis) of the food ingredient out of the total weight of the legume-derived food ingredient.

In some embodiments, the legume-derived food ingredient comprises up to about 0.7% legume starch, at times up to about 0.6%, at times up to about 0.5% legume starch, at times up to about 0.4%, at times up to about 0.3%, at times up to about 0.2% and at times up to about 0.1% legume starch out of the total weight of the legume-derived food ingredient.

In some embodiments, the legume-derived food ingredient comprises about 0.1% legume starch, at times about 0.2%, at times about 0.3%, at times about 0.4% legume starch, at times about 0.5%, at times about 0.6%, at times about 0.7% and at times about 0.8% legume starch out of the total weight of the legume-derived food ingredient.

In some embodiments, the legume-derived food ingredient comprises between about 0.01% and about 0.8% legume starch, at times about 0.05% and about 0.8%, at times about 0.07% and about 0.8%.

In some embodiments, the legume-derived food ingredient comprises between about 0.01% and about 0.5% legume starch, at times about 0.05% and about 0.5%, at times about 0.07% and about 0.5%.

In some embodiments, the legume-derived food ingredient comprises between about 0.05% and about 0.1% legume starch.

As shown in the Examples herein below, the legume-derived food ingredient includes is free of legume starch, at times comprises starch at an amount that is below 0.1% out of the total weight of the legume-derived food ingredient. It was suggested that the legume-derived food ingredient is at times, essentially free from starch.

The amount of starch can be measured by any known method in the field. For example, using a polarimetric (or Ewers') method, which hydrolyzes starch granules to glucose by boiling in dilute hydrochloric acid (HCl), and hence ensuring complete release of the starch granules from the protein matrix.

It is of note that when referring to a food ingredient free of legume starch it encompasses a food ingredient which comprises legume starch in amount that is undetectable in a method used to determine legume starch such as the methods described herein.

As also detailed herein, the legume-derived food ingredient comprises legume proteins. In the context of the present disclosure, legume proteins refer to proteins or subunits thereof (e.g. polypeptide chain) that are identified in the art to be present in legume.

In some embodiments, the legume-derived food ingredient comprises at least about 20% w/w proteins.

In some embodiments, the legume-derived food ingredient comprises between about 20% and about 40% legume proteins, at times between about 20% and about 35%, at times between about 20% and about 32%, at times between 20% and about 30%, at times between 22% and about 30%, at times between 23% and 30% legume proteins out of the total weight of the legume-derived food ingredient. In some embodiments, the legume-derived food ingredient comprises about 23% (dw) legume proteins out of the total weight of the legume-derived food ingredient. In some embodiments, the legume-derived food ingredient comprises about 26% legume proteins out of the total weight of the legume-derived food ingredient.

In some embodiments, the legume proteins are water soluble proteins.

In some embodiments, the legume protein is or comprises at least one of a globulin protein, an albumin protein, a glutelin protein, a prolamin protein or any subunit thereof.

Globulin are known as storage proteins found in plant seeds including mainly vicilins (7S globulins) having a molecular weight of between 145 and 190 kDa and legumins (11S globulins) having a molecular weight of between 320 and 400 kDa.

In some embodiments, the legume protein is or comprises low molecular weight proteins (LMWP). LMWP as used herein refers to proteins, proteins subunits and polypeptides thereof, having a molecular weight from about 12 kDa to about 26 kDa.

In some embodiments, the legume protein is or comprises albumin subunits or vicilin subunit.

Albumin proteins as used herein refer to albumin proteins found in legume seeds often denoted as legumelin. In some embodiments, the legume protein is or comprise 2S albumin.

Vicilin is isolated from different leguminous seeds and is serves as a storage protein. In some embodiments, the legume protein is or comprise 7S vicilin.

As shown in the examples below, sodium dodecyl sulfate-polyacrylamide gel electrophoresis (SDS-PAGE) was used to determine the protein molecular masses/molecular weight distribution in the legume-derived fraction. As appreciated, the intensity of a specific band in the SDS-PAGE can be correlated with the relative amount (concentration) of the specific protein.

In some embodiments, at least about 46% of the legume proteins in the legume-derived fraction have a molecular weight (MW) of about 12 kDa, at times at least about 50%, at times at least about 60%, at times at least about 65%, at times at least about 70% of the legume proteins in legume-derived fraction have a MW of about 12 kDa.

In some embodiments, between about 46% and about 90% of legume proteins in the legume-derived fraction have a MW of about 12 kDa, at times between 50% and about 80%, at times between about 60% and about 80%, at times between about 65% and about 75%, at times between about 70% and about 73% of legume proteins in the legume-derived fraction have a MW of about 12 kDa.

Without being bound thereto, it was suggested that the proteins having a MW of about 12 kDa correspond to legume albumin proteins, for example to chickpea proteins or subunit thereof. Hence, in some examples, albumin proteins subunit such as 7S albumin having a MW of about 12 kDa represent at least about 46%, at times about 50%, at times at least about 60%, at times at least about 65%, at times at least about 70% of the legume proteins in the legume-derived fraction.

In addition to the proteins having a MW of about 12 kDa, the legume-derived fraction is characterized by proteins having MW of about 14 kDa, 16 kDa, 17 kDa and 22 kDa, as determined in the SDS-PAGE results.

In some embodiments, up to about 28% of the proteins in the legume-derived fraction correspond to proteins having a MW of between about 14 kDa and about 17 kDa, at times up to about 25% of the proteins in the legume-derived fraction correspond to proteins having a MW of between about 14 kDa and about 17 kDa. In some other embodiments, up to about 15% of the proteins in the legume-derived fraction correspond to proteins having a MW of between about 14 kDa and about 17 kDa.

Without being bound thereto, it was suggested that the proteins having a MW of between about 14 kDa and about 17 kDa are polypeptide chains that are subunits of albumin protein and/or subunits of vicilin protein.

In some embodiments, up to about 18% of the legume proteins have a MW of between about 16 kDa and 17 kDa, at times up to about 15% of the legume proteins have a MW of between about 16 kDa and 17 kDa, at times up to about 12% of the legume proteins have a MW of between about 16 kDa and 17 kDa, at times up to about 10% of the legume proteins have a MW of between about 16 kDa and 17 kDa, at times up to about 8% of the legume proteins have a MW of between about 16 kDa and 17 kDa and at times up to about 5% of the legume proteins have a MW of between about 16 kDa and 17 kDa.

In some other examples, between about 1% and about 18%, at times between about 3% and about 15%, at times between about 3% and about 12%, between about 5% and about 10% of the legume protein a MW of between about 16 kDa and 17 kDa.

It should be noted that while the MW protein determination was performed, as shown in the examples below, using SDS-PAGE, any experimental method that is suitable for MW determination of a protein may be used.

In some embodiments, the legume protein and the legume starch are both derived from the same legume.

As described herein, the legume-derived food ingredient comprises saccharides.

In some embodiments, the saccharides in the legume-derived food ingredient comprises a mixture of monosaccharides, disaccharides, oligosaccharides and polysaccharides.

In some embodiments, the legume-derived food ingredient comprises at least about 5% saccharides, at least about 6%, at least about 8%, at least about 10% saccharides, at least about 13%, at least about 15%, at least about 18%, at times at least about 20% saccharides on dry basis, out of the total weight of the legume-derived food ingredient. In some embodiments, the saccharides in the legume-derived food ingredient comprises a mixture of monosaccharides, disaccharides and polysaccharides.

In some embodiments, the legume-derived food ingredient comprises a mixture of monosaccharides, disaccharides and oligosaccharides.

In some embodiments, the legume-derived food ingredient comprises at least about 5% of a mixture of monosaccharides, disaccharides and oligosaccharides, at times at least about 6%, at times at least about 8%, at times at least about 10% saccharides, at times at least about 13%, at times at least about 15%, at times at least about 18%, at times at times at least about 20% of a mixture of monosaccharides, disaccharides and oligosaccharides on dry basis, out of the total weight of the legume-derived food ingredient.

In some embodiments, the legume-derived food ingredient comprises a mixture of monosaccharides, disaccharides and oligosaccharides of between about 5% and about 25%, between about 6% and about 25%, between about 10% and about 25%, between about 15% and about 25% on dry basis, out of the total weight of the legume-derived food ingredient.

In some embodiments, the legume-derived food ingredient comprises about 5% of a mixture of monosaccharides, disaccharides and oligosaccharides, at times about 6%, at times about 8%, at times about 10% saccharides, at times about 13%, at times about 15%, at times about 18%, at times about 20%, at times about 22%, at times about 25% of a mixture of monosaccharides, disaccharides and oligosaccharides on dry basis, out of the total weight of the legume-derived food ingredient.

In some embodiments, the saccharides in the legume-derived food ingredient comprises oligosaccharides. In some embodiments, the saccharides in the legume-derived food ingredient comprises polysaccharides.

In some embodiments, the sugar comprises a combination of sugars.

In some embodiments, the sugar comprises monosaccharides, disaccharides or a combination thereof.

In some embodiments, the saccharides in the legume-derived food ingredient comprises monosaccharides.

In some embodiments, the saccharides in the legume-derived food ingredient comprises disaccharides.

In some examples, the legume derived food ingredient comprises at least about 5% of monosaccharides and/or disaccharides (i.e. sugars), at times at least about 8% of monosaccharides and/or disaccharides, at times at least about 10% of monosaccharides and/or disaccharides, at times at least about 11% of monosaccharides and/or disaccharides, at times at least 13% monosaccharides and/or disaccharides at times at least 15% of monosaccharides and/or disaccharides and at times at least 20% of monosaccharides and/or disaccharides out of the total weight of the legume-derived fraction.

In some embodiments, the legume-derived food ingredient comprises at least 5% of monosaccharides and/or disaccharides (i.e. sugars), at time at least about 8% of monosaccharides and/or disaccharides, at times at least about 10% of monosaccharides and/or disaccharides, at times at least about 11% of monosaccharides and/or disaccharides out of the total weight of the legume-derived food ingredient.

In some embodiments, the legume-derived food ingredient comprises at least 8% of monosaccharides and disaccharides (i.e. sugars), at times at least about 10% of monosaccharides and disaccharides, at times at least about 11% of monosaccharides and disaccharides, at times at least about 12% of monosaccharides and disaccharides, at times at least 13% out of the total weight of the legume-derived food ingredient.

In some embodiments, the legume-derived food ingredient comprises between about 8% and about 20% of monosaccharides and disaccharides (i.e. sugars), at times between about 8% and about 18%, at times between about 8% and about 15%, at times between about 10% and about 15% monosaccharides and disaccharides out of the total weight of the legume-derived food ingredient.

In some embodiments, the combination of sugars comprises at least one of fructose, glucose, maltose, galactose and sucrose.

In some embodiments, the combination of sugars comprises at least one of fructose, glucose, maltose, and sucrose.

In some embodiments, the sugar comprises at least sucrose.

In some embodiments, the combination of sugars comprises at least one of fructose, glucose, and maltose, in addition to the sucrose.

In some embodiments, the combination of sugars comprises fructose and sucrose.

In some embodiments, the legume-derived food ingredient comprises at least 3%, at times at least 4%, at times at least 4.5%, at least 5%, at times at least 5.5%, at times at least 6%, at times at least 7%, at times at least 8%, at times at least 8.5% sucrose, at times at least 10% and at times at least 15% sucrose out of the total weight of the legume-derived food ingredient.

In some embodiments, the legume-derived food ingredient comprises between about 3% and about 10% sucrose, at times between about 3% and about 8%, at times between about 3% and about 7%, at times between about 4% and about 6% sucrose, out of the total weight of the legume-derived food ingredient.

In some embodiments, the legume-derived food ingredient comprises between about 5% and about 20% sucrose, at times between about 5% and about 15%, at times between about 5% and about 10%, at times between about 8% and about 9% sucrose, out of the total weight of the legume-derived food ingredient.

In some embodiments, the legume-derived food ingredient comprises about 4%, about 5%, about 5.5% sucrose, about 6% sucrose.

In some embodiments, the legume-derived food ingredient comprises about 8%, about 8.5%, about 9% sucrose.

In some examples, the legume-derived food ingredient comprises at least 0.5% fructose, at least 1% or at least 1.5% fructose.

In some examples, the legume-derived food ingredient comprises at least 2% fructose, at least 2.5%, at least 3% fructose, at least 3.5% fructose, at least 4%, at least 4.5, at least 5% or at least 5.5% fructose.

In some examples, the sugar comprises between about 0.5% and about 3% fructose, at times between about 0.5% and about 2.5%, at times between about 1% and about 2% fructose out of the total weight of the legume-derived food ingredient.

In some examples, the sugar comprises about 1%, at times about 1.5%, at times about 1.7% fructose out of the total weight of the legume-derived food ingredient.

In some examples, the sugar comprises between about 2% and about 10% fructose, at times between about 3% and about 10%, at times between about 4% and about 8%, at times between about 4% and about 6% fructose out of the total weight of the legume-derived food ingredient.

In some embodiments, the legume-derived food ingredient comprises about 4%, about 5%, about 5.5% fructose, about 6% fructose.

In some embodiments, the combination of sugars comprises glucose.

In some examples, the legume-derived food ingredient comprises at least 0.7%, at times at least 1% glucose, at least 1.5%, at least 1.7% glucose, at least 1.8% glucose, at least 1.9% glucose.

In some examples, the sugar comprises between about 0.7% and about 3% glucose, at times between about 1% and about 2.5%, at times between about 1% and about 3% glucose out of the total weight of the legume-derived food ingredient.

In some examples, the sugar comprises about 1%, at times about 1.5%, at times about 1.7% glucose out of the total weight of the legume-derived food ingredient.

In some examples, the legume-derived food ingredient comprises glucose in an amount of at most about 1%, at times at most about 0.4% (w/w).

In some examples, the legume-derived sugar food ingredient comprises up to about 0.4% glucose.

In some examples, the legume-derived food ingredient comprises maltose in an amount of at most about 1%, at times at most about 0.4% (w/w).

In some examples, the legume-derived sugar food ingredient comprises up to about 0.4% maltose.

It is of note that reference made herein to the % of sugars is made to the % as measured in dry basis.

In some embodiments, the food ingredient comprises oligosaccharides. In some embodiments, the food ingredient comprises at least 4% oligosaccharides, at times at least 4.5%, at times at least 5%, at times 5.5%, at times at least 6% oligosaccharides as measured on dry basis of the food ingredient.

In some embodiments, the food ingredient comprises oligosaccharides. In some embodiments, the food ingredient comprises between about 3% and about 8%, at times at least between 3% and about 7%, at times between about 4% and about 7%, at times between 5% and about 7% oligosaccharides as measured on dry basis of the food ingredient.

In some embodiments, the oligosaccharides are at least one of raffinose, stachyose, verbacose or combination thereof.

In some embodiments, the food ingredient comprises between about 2% and about 6% stachyose as measured on dry basis, at times between 3% and about 6%, at times between 4% and about 6% stachyose as measured on dry basis.

In some embodiments, the food ingredient comprises about 3% stachyose as measured on dry basis, at times about 3.5%, at times about 4%, at times about 4.2%, at times about 4.4%, at times about 4.5%, at times about 4.6%, at times about 4.7%, at times about 4.8%, at times about 5% stachyose as measured on dry basis.

In some embodiments, the food ingredient comprises between about 0.5% and about 2% raffinose as measured on dry basis, at times between 0.7% and about 1.5%, at times between 0.8% and about 1.3% raffinose as measured on dry basis.

In some embodiments, the food ingredient comprises about 0.8% raffinose as measured on dry basis, at times about 0.9%, at times about 4%, at times about 1%, at times about 1.2%, at times about 1.4%, at times about 1.5%, raffinose as measured on dry basis.

In some embodiments, the food ingredient comprises between about 0.05% and about 0.7% verbacose as measured on dry basis, at times between 0.1% and about 0.5%, at times between 0.1% and about 0.4% verbacose as measured on dry basis.

In some embodiments, the food ingredient comprises about 0.05% verbacose as measured on dry basis, at times about 0.07%, at times about 0.1%, at times about 0.15%, at times about 0.2%, at times about 0.25%, at times about 0.3%, verbacose as measured on dry basis.

In some embodiments, the ratio between the oligosaccharides and the sugars (monosaccharides and/or disaccharides) in the legume-derived food ingredient is between 1:100 and 100:1. In some embodiments, the ratio between the oligosaccharides and the sugars (monosaccharides and/or di-saccharides) in the legume-derived food ingredient is 1:5, at times 1:4, at times about 1:3, at times about 1:25, at times about 1:2, at times 1:1,

Examples of the sugar composition of the legume-derived food ingredient are shown in any one of Tables 3A, 3B, 3C in the examples below.

The amount and composition of the saccharides and/or sugar in the legume-derived food ingredient can be determined by any method known in the art. For example, and as shown in the Examples below which form an integral part of the present disclosure, such methods may include High Performance Liquid Chromatography (HPLC) and/or refractometer. Specifically, HPLC allows identification and quantification of various sugars such as fructose, maltose, glucose, and sucrose. The sugars (identification and quantification) in the legume-derived fraction are determined vis-à-vis calibration curves that are obtained by plotting peak area versus pre-determined concentration of each sugar.

In addition, the amount of soluble sugars can be determined using a refractometer. A refractometer can measure the total amount of soluble solids including sugars by determining the extent of light refraction (as part of a refractive index) of transparent substances in either a liquid or solid state; this is then used in order to quantify a known liquid sample.

The legume derived food ingredient comprises dietary fibers. The dietary fibers are from a legume source.

In some embodiments, the food ingredient comprises at least about 18% dietary fibers, at times at least about 20%, at times at least about 22%, at times at least 24%, at times at least about 25% dietary fibers measured on dry basis.

In some embodiments, the food ingredient comprises between about 15% and about 40% dietary fibers, at times between about 18% and about 35%, between about 18% and about 33%, between about 20% and about 30% dietary fibers measured on dry basis.

In some embodiments, the food ingredient comprises about 18% dietary fibers, at times about 20%, at times about 22%, at times about 24%, at times about 25% dietary fibers measured on dry basis.

The amount of fibers can be measured by any method (e.g. analytical method) known in the art. For example, the fiber can be measured by one of the following methods: nonenzymatic-gravimetric, enzymatic-gravimetric, or enzymatic-chemical methods, which may include enzymatic-colorimetric or enzymatic-GLC/HPLC.

In some examples, the fibers can be measured by enzymatic-gravity method. The enzymatic-gravimetric method typically measures the sum of soluble and insoluble dietary fibers, such as polysaccharides and lignin as a unit.

Legume fibers encompasses both soluble fibers and insoluble fibers. As appreciated, soluble fiber dissolves in water and are typically broken by bacteria in the large intestine whereas insoluble fiber does not dissolve in water and passes through the gastrointestinal tract relatively intact.

In addition to soluble and insoluble, fibers can be defined by the degree of polymerization. For example, high molecular weight (HMW) fibers are considered for molecules having for example, more than 10 monomeric units and low molecular weight (LMW) fibers are considered as having less monomeric units. In some embodiments, the food ingredient comprises between about 15% and about 30% low molecular weight fibers, at times between about 18% and about 30%, at times between about 18% and about 27%, at times between about 18% and about 26%, at times between about 18% and 25%, at times between about 20% and about 25% low molecular weight fibers out of the total weight.

In some embodiments, the food ingredient comprises about 15%, at times about 18%, at times about 20%, at times about 21%, at times about 22%, at times about 23%, at times about 25% low molecular weight fibers out of the total weight.

In some examples, soluble LMW fibers comprise dextrin, polydextrose or combination thereof.

In some embodiments, the food ingredient comprises between about 0.5% and about 4% soluble HMW fibers, at times between about 0.8% and about 3.5%, at times between about 1% and about 3% soluble HMW fibers.

In some embodiments, the food ingredient comprises about 0.5% soluble HMW fibers, at times 1%, at times 1.5%, at times 2%, at times 2.5% soluble HMW fibers.

In some examples, soluble HMW fibers comprise (1-3),(1-4)-β-glucan, inulin or combination thereof.

In some embodiments, the food ingredient comprises less than about 0.4% insoluble HMW fibers, at times less than about 0.2% insoluble HMW fibers.

In some embodiments, the food ingredient comprises between about 0.1% and about 0.4% insoluble HMW fibers, at times about 0.2% insoluble HMW fibers.

In some examples, insoluble HMW fibers comprise cellulose, hemicellulose lignin or combination thereof.

The food ingredient is further characterized by having a low-fat content.

The fat content can be measured by any method known in the art.

In some embodiments, the food ingredient comprises at most 0.9% fat, at times at most 0.8%, at times at most 0.7% fat as dry basis.

In some embodiments, the food ingredient comprises between about 0.1% and about 1.5% fat, at times between about 0.4% and about 1% fat, between about 0.5% and about 0.9% fat.

In some embodiments, the food ingredient comprises about 0.4% fat, at times about 0.5%, at times about 0.6%, at times about 0.7%, at times about 0.8% fat.

The food ingredient comprises saponins. In some embodiments, the food ingredient comprises at most about 95%, at times at most about 90%, at times at most about 85%, at times at most about 80%, at times at most about 75%, at times at most about 70%, at times at most about 65%, at times at most about 60%, at times at most about 55%, at times at most about 50%, at times at most about 45%, at times at most about 40%, at times at most about 35%, at times at most about 30%, at times at most about 25% saponin.

In some embodiments, the food ingredient comprises between about 5% and about 90% saponins, between about 10% and about 80% saponins, between about 15% and about 80% saponins, between about 20% and about 80% saponins, between about 25% and about 80% saponins, between about 30% and about 80% saponins, between about 35% and about 80% saponins, between about 40% and about 80% saponins, between about 45% and about 80% saponins, between about 55% and about 80% saponins, between about 55% and about 80% saponins, between about 60% and about 80% saponins, between about 60% and about 75% saponins.

Without being bound by theory, it may be suggested that the foaming capability of the food ingredient may be at least partially due to the presence of saponins.

In some embodiments, the food ingredient comprises at most 0.8% legume starch, at least 20% legume proteins and sugars.

In some embodiments the food ingredient comprises between about 23% and 30% legume proteins and is free of legume starch.

In some embodiments the food ingredient comprises between about 23% and 30% legume proteins, between about 10% and 15% total monosaccharides and disaccharides and is free of legume starch.

In some embodiments the food ingredient comprises between about 23% and 30% legume proteins, between about 10% and 15% total monosaccharides and disaccharides, between about 5% and about 7% oligosaccharides and is free of legume starch.

In some embodiments the food ingredient comprises between about 23% and 30% legume proteins, between about 10% and 15% total monosaccharides and disaccharides, between about 5% and about 7% oligosaccharides, between about 22% and about 28% legume fibers and is free of legume starch.

In some embodiments the food ingredient comprises between about 23% and 30% legume proteins, between about 10% and 15% total monosaccharides and disaccharides, between about 5% and about 7% oligosaccharides, between about 22% and about 28% legume fibers, between about 0.5% and about 1% fat and is free of legume starch.

In some embodiments the food ingredient comprises between about 23% and 30% legume proteins, between about 10% and 15% total monosaccharides and disaccharides, between about 5% and about 7% oligosaccharides, between about 22% and about 28% legume fibers, between about 0.5% and about 1% fat, at most 70% saponins and is free of legume starch.

The present disclosure is not limited to a specific legume. In some embodiments, the legume is selected from the group consisting of chickpeas, alfalfa, clover, beans, peas, lentils, lupins, mesquite, carob, soybeans, peanuts, and tamarind. In some embodiments, the legume is chickpea.

In accordance with some embodiments that may be considered as some aspects, the present disclosure provides a chickpea derived food ingredient.

In accordance with some embodiments that may be considered as some aspects, the present disclosure provides a chickpea derived food ingredient comprising at most 0.8% chickpea starch and at most 60% solid content.

In some embodiments the food ingredient is free of chickpea starch.

The chickpea in accordance with the present disclosure refers to any type of the Cicer arietinum including, inter alia, Kabuli, Amethyst, Desi, Flipper, Kyabra, Jimbour, Moti and Yorker.

The legume derived food ingredient of the present disclosure may be in various forms. For example, provided as a solution or a powder, the latter will be mixed with a liquid such as an aqueous solution.

The food ingredient can form a foam and is for use as a foaming agent. It should be noted that the foaming agent initiates and/or facilitates formation of foam volume and/or enhances the stability of the foam by holding onto the air bubbles, for example during mixing.

As described herein and also shown in the Examples below, the legume derived food ingredient, formed a foam that was found to be stable for at least 30 minutes.

In some examples, the legume derived food ingredient is defined by its foaming properties or quality.

In one example, the legume derived food ingredient is defined by a foaming capacity. Foaming capacity (overrun) refers to a % increase in volume of the formed foam.

In some examples, the legume derived food ingredient is characterized by a foaming capacity of at least 350%, at times at least 400%, at times at least 500%, at times at least 550%, at times at least 600%, at times at least 650%, at times at least 700%, at times at least 800% and at times at least 900%, after a mixing time of 3 minutes, at times 6 minutes, at times 7 minutes and at times 8 minutes maximum mixing speed (#6) or (#7) with a whisking hook using a home whipping device.

In some examples, the legume derived food ingredient is characterized by a foaming capacity of at least 600%, at times at least 650%, at times at least 700%, after a mixing time of 3 minutes, at times 6 minutes, at times 7 minutes and at times 8 minutes at maximum mixing speed (#6) or (7) with a whisking hook using a home whipping device.

In some embodiments, the legume derived food ingredient is characterized by a foaming capacity of between about 350% and about 1000%, at times between about 650% and about 1000%, between about 700% and about 1000%, between about 700% and about 750, %, after a mixing time of 3 minutes, at times 6 minutes, at times 7 minutes and at times 8 minutes at maximum mixing speed (#6) or #7 with a whisking hook using a home whipping device.

In one example, the food ingredient is defined by foaming stability. Foaming stability refers to a % change in the volume of the formed foam after time a period.

In some embodiments, the legume derived food ingredient is characterized by a foaming stability of at least 80%, at times at least 85%, at times at least 90%, at times at least 95%, at times at least 96%, at times at least 97% and at times at least 98% after about 30 minutes from foaming, after a mixing time of 6 minutes at maximum mixing speed (#6) or (#7) with a whisking hook using a home whipping device.

In some embodiments, the legume derived food ingredient is characterized by a foaming stability of between about 85% and about 100%, and at times between 90% and 100% after about 30 minutes from foaming, after a mixing time of 3 minutes, at times 6 minutes, at times 7 minutes and at times 8 minutes at maximum mixing speed (#6) or (#7) with a whisking hook using a home whipping device.

In one example, the food ingredient is defined by liquid syneresis. Foam syneresis refers to the flow of liquid through a foam, driven by gravity and capillarity. In some embodiments, the legume derived food ingredient is characterized by a liquid drainage of at least 2%. In some embodiments, the legume derived fraction is characterized by a liquid drainage of between 2% and 9%.

It is noted that an increase in foam volume (i.e. foaming capacity) and foaming stability and reduction in syneresis are considered positive for food foams.

Surprisingly, and as noted above, the foam formed from the legume derived food ingredient of the present disclosure was as stable as the foam formed from both egg whites and aquafaba. As shown in the Examples below, the legume derived food ingredient comprises a significantly lower amount of starch than aquafaba. Without being bound by theory, it was suggested that the improved stability of the foam formed by the legume derived food ingredient may be attributed, at least in part, to the presence of high amounts of albumin-derived polypeptides and/or vicilin-derived polypeptides

The legume derived food ingredient can be prepared by various process. In some examples, the legume derived food ingredient can be prepared by treating an aqueous legume derived fraction that includes soluble proteins and sugars to obtain a legume-derived food ingredient that has a high solid content.

The legume-derived aqueous fraction in accordance with some embodiments may be obtained from legumes, for example, during legume protein isolation (separation, extraction), by various methods, including, inter alai, ultra filtration, salt extraction, organic solvents extraction or acid precipitation. In some embodiments, the legume-derived aqueous fraction can be obtained by cooking legume (denoted at times as aquafaba).

In some other examples, the legume derived food ingredient can be prepared by using a legume flour as a starting material. Legume flour can be obtained by grinding raw legume by any method known in the field.

In some examples, for the preparation of a legume derived food ingredient, the legume flour is mixed with a basic pH adjusting agent. The mixing can be done by any method known in the field, under conditions including, inter alia, time of mixing and temperature of mixing, to obtain a basic slurry. The mixing conditions are selected to allow the legume flour to fully dissolve.

In some embodiments, the mixing is by stirring using a high shear mixer. In some embodiments, the mixing is by using a blender.

In some embodiments, the mixing is at a temperature of between about 20° C. and about 55° C., at times between about 30° C. and about 55° C., at times between about 40° C. and about 55° C. and at times between about 45° C. and about 55° C. In some embodiments, the mixing is at a temperature of about 45° C., at times about 50° C. and at times about 55° C.

In some embodiments, the mixing is by agitating the legume flour with a basic pH adjusting agent. The basic pH adjusting agent as used herein refers to an agent that is capable of increasing the pH value of a solution to which it is added. In some embodiments, the basic pH adjusting agent is an alkali metal salt. In some embodiments, the basic pH adjusting agent is an inorganic hydroxide.

In some embodiments, the basic pH adjusting agent is at least one of sodium hydroxide, potassium hydroxide, magnesium hydroxide, beryllium hydroxide, strontium hydroxide, and barium hydroxide or calcium hydroxide. In some embodiments, the basic pH adjusting agent is sodium hydroxide.

The amount of the basic pH adjusting agent may be added as to obtain a required pH.

The first liquid fraction may be isolated from the basic slurry by any known method in the field. In some embodiments, the isolation is by centrifugation. The centrifugation may be conducted under conditions allowing precipitation and isolation of the solution (supernatant) comprising the first liquid fraction. The centrifugation may be for a time period of between about 10 minutes and 60 minutes, operating at a temperature of between about 30° C. and about 60° C.

In some examples, the first liquid fraction is treated an acidic pH adjusting agent. The treatment is done under conditions that allow formation of an acidic slurry.

The acidic pH adjusting agent as used herein refers to an agent that is capable of decreasing the pH value of a solution to which it is added. In some embodiments, the acidic pH adjusting agent is an organic or an inorganic acid. In some embodiments, the acidic pH adjusting agent is an inorganic acid. In some embodiments, the inorganic acid is at least one of hydrogen chloride acid (HCl), hydrofluoric acid (HF), hydrobromic acid (HBr), hydroiodic acid (HI), sulfuric acid, phosphoric acid, nitric acid, boric acid or carbonic acid. In some embodiments, the acidic pH adjusting agent is an organic acid. In some embodiments, the organic acid is at least one of citric acid, carboxylic acid, tartaric acid or malic acid.

After formation of the acidic slurry, a second liquid fraction is isolated. The second liquid fraction may be isolated from the acidic slurry by any known method in the field.

In some embodiments, the isolation is by centrifugation. The centrifugation may be conducted under conditions allowing precipitation and isolation of the solution (supernatant) comprising the second liquid fraction. The centrifugation may be for a time period of between about 10 minutes and 60 minutes, operating at a temperature of between about 30° C. and about 60° C.

In some embodiments, the isolated first liquid fraction is or comprises the legume derived aqueous fraction. In some embodiments, the isolated second liquid fraction is or comprises the legume derived aqueous fraction.

The legume derived aqueous fraction being basic or acidic can be used for the preparation of the legume derived food ingredient.

The legume derived aqueous fraction obtained by any method described herein is further treated to obtain a food ingredient comprising at most 60% w/w of solid content. In some embodiments, the aqueous fraction obtained during legume protein isolation is treated to obtain a food ingredient comprising at most 60% w/w of solid content. In some examples, the aqueous fraction obtained during legume protein isolation as described in Example 1 is treated to obtain a food ingredient comprising at most 60% w/w of solid content.

In some embodiments, treating the aqueous legume derived fraction is by a concertation method. In some embodiments, the methods comprising concentrating the legume derived aqueous fraction to obtain the legume derived food ingredient.

In some embodiments, treating is by heating, drying, evaporating, vacuum evaporation, reverse osmosis, membrane filtration, partial freezing, centrifugation, liquid-liquid phase separation and participation.

In some embodiments, concentrating is by heating, drying, evaporating, vacuum evaporation, reverse osmosis, membrane filtration, partial freezing, centrifugation, liquid-liquid phase separation and participation.

It is of note that treating the fraction by any of the methods described herein is under conditions including, inter alia, time and temperature sufficient to allow contorting the fraction. It is of further note that the time of concentrating is for a sufficient time required to obtain the specific % of solid content. The time can depend on various conditions, including, inter alia, volume of the sample.

In accordance with some embodiments, treating is by heating. Heating can be done by any method known in the art.

In some embodiments, treating is by evaporation of at least a portion of a liquid. In some embodiments, treating is by drying at least a portion of a liquid.

In some examples, concentrating is by a temperature of to between about 50° C. and about 100° C.

In some embodiments, the legume derived aqueous fraction is treated by heating to a temperature of about 100° C.

As appreciated, calculating the % of solid content after a time period can be done by any known method in the art and as described herein, for example by using a moisture analyzer. In some examples, a sample comprising the legume derived aqueous fraction is concentrated by heating, e.g. by evaporating to a temperature of abut 100° C. and at a specific time point, which may be a predetermined time point, a sample is tested for the % of solid content.

In some examples, the legume derived aqueous fraction is heated for about 3 hours to obtain a food ingredient comprising 40% solid content.

In some embodiments which can be considered as aspects of the disclosure, the methods described herein comprise providing an aqueous legume derived fraction and concentrating the legume derived fraction to obtain a legume-derived food ingredient characterized by a solid content of at most 60%.

In some embodiments, the methods described herein comprise providing an aqueous legume derived fraction and concentrating the legume derived fraction to obtain a legume-derived food ingredient characterized by a solid content of at most 60% and comprising at most 0.8% legume starch.

In some embodiments, the methods described herein comprise providing an aqueous legume derived fraction and concentrating, optionally by heating, the legume derived fraction to obtain a legume-derived food ingredient characterized by a solid content of at most 60% and being essentially free from legume starch.

In some embodiments, providing the aqueous legume derived fraction comprises mixing legume flour with a basic pH adjusting agent to obtain a basic slurry with a basic pH and isolating a first liquid fraction from the basic slurry to obtain the aqueous legume derived fraction.

In some embodiments, providing the aqueous legume derived fraction comprises
mixing legume flour with a basic pH adjusting agent to obtain a basic slurry with a basic pH;
isolating a first liquid fraction from the basic slurry;
treating the first liquid fraction with an acidic pH adjusting agent to obtain an acidic slurry;
isolating a second liquid fraction from the acidic slurry to obtain the aqueous legume derived fraction.

In some embodiments which can be considered as aspects of the disclosure, the methods described herein comprise
mixing legume flour with a basic pH adjusting agent to obtain a basic slurry with a basic pH;
isolating a first liquid fraction from said basic slurry;
concentrating the first liquid fraction to obtain a legume-derived food ingredient characterized by a solid content of at most 60%.

In some embodiments which can be considered as aspects of the disclosure, the methods described herein comprise
mixing legume flour with a basic pH adjusting agent to obtain a basic slurry with a basic pH;
isolating a first liquid fraction from said basic slurry;
treating the first liquid fraction with an acidic pH adjusting agent to obtain an acidic slurry;
isolating a second liquid fraction from the acidic slurry and
concentrating the second liquid fraction to obtain a legume-derived food ingredient characterized by a solid content of at most 60%.

In some embodiments, concentrating is by heating as detailed herein.

The legume derived food ingredient of the present disclosure may have various uses as a food product. In some examples, the legume derived food ingredient is for use as an egg white replacer.

In accordance with some other aspects, the present disclosure provides a food product comprising the legume derived food ingredient. To this end, the product can be a final, ready for consumption product, or is the food ingredient) for the preparation of a final food product.

The food product in accordance with some embodiments, is in a form of a foam formed from the legume derived food ingredient. In some embodiments, the food product is foamed whipping-cream. The foamed whipping-cream can be used per se or as a food ingredient in the preparation of a final, ready for consumption food products as described herein. The food product may be a non-cooked product or alternatively a based food product.

In some embodiments, the food product is at least one of whipping cream, mousse or ice cream.

In some embodiments, the foam formed is used as an egg white replacement in the preparation of the food product.

The food product comprising the foam as an egg white replacement may be a non-baked food product. In some examples, the food product is at least one of aioli, butter or mayonnaise.

In some examples, the food product is a beverage. In some embodiments, the food product is an alcoholic cocktail.

In accordance with such embodiments, the formed foam can be used as an egg replacement in the preparation of baked food products. As shown in the Examples below, heating the formed foam did not negatively affect the food product.

In some embodiments, the food product is a bakery or a pastry product. In accordance with other embodiments, the food product is a basked product or cooked product.

In some examples, the food product is a cake or a cookie. In some examples, the food product is at least one of meringue, pavlova, macarons, marshmallows or muffins.

In accordance with some embodiments, the food product comprising the legume derived food ingredient in combination with a bulking agent. A bulking agent refers to a nutritive substance such as starch or non-starch polysaccharide that is used to increase the bulk-volume of a food, typically, without affecting the taste without affecting the utility and functionality. In some embodiments, the bulking agent is at least one of potassium bitartrate, aluminum ammonium sulfate, aluminum potassium sulfate, ammonium hydrogen carbonate, sodium hydrogen carbonate, guar gum, psyllium husk, carnuba wax, glycerin, beta, glucan, mannitol, maltitlol, polydextrose, methylcellulose, dextrin or pectin. In some embodiments, the bulking agent is dextrin, dextrose or equivalents thereof. As appreciated, dextrin refers to any of a range of polymers of glucose, intermediate in complexity between maltose and starch, produced by the enzymatic hydrolysis of starch or by applying dry heat under acidic conditions; used commercially as adhesives and dextrose refers to a naturally-occurring dextrorotatory form of glucose monosaccharide molecule. In some embodiments, the bulking agent is at least one of maltodextrins, sucrose or starch.

The term “about” as used herein indicates values that may deviate up to 1%, more specifically 5%, more specifically 10%, more specifically 15%, and in some cases up to 20% higher or lower than the value referred to, the deviation range including integer values, and, if applicable, non-integer values as well, constituting a continuous range. For example, a pH value described herein may be within ±0.5 or ±0.2 of the indicated value.

It should be noted that various embodiments of this invention may be presented in a range format. The description of a range should be considered to have specifically disclosed all the possible sub ranges as well as individual numerical values within that range. For example, description of a range such as from 1 to 6 or between 1 and 6 should be considered to have specifically disclosed sub ranges such as from 1 to 3, from 1 to 4, from 1 to 5, from 2 to 4, from 2 to 6, from 3 to 6 etc., as well as individual numbers within that range, for example, 1, 2, 3, 4, 5, and 6.

It is to be understood that the terminology used herein is used for the purpose of describing particular embodiments only and not intended to be limiting since the scope of the present invention will be limited only by the appended claims and equivalents thereof.

Throughout this specification and the Examples and claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

It must be noted that, as used in this specification and the appended claims, the singular forms “a”, “an” and “the” include plural referents unless the content clearly dictates otherwise.

The following examples are representative of techniques employed by the inventors in carrying out aspects of the present invention. It should be appreciated that while these techniques are exemplary of preferred embodiments for the practice of the invention, those of skill in the art, in light of the present disclosure, will recognize that numerous modifications can be made without departing from the spirit and intended scope of the invention.

It should be noted that the various embodiments and examples detailed herein in connection with various aspects of the invention may be applicable to one or more aspects disclosed herein. It should be further noted that any embodiment described herein, for example, related to components of the food ingredient, may be applied separately or in various combinations. Various embodiments and aspects of the present invention as delineated hereinabove and as claimed in the claims section below find experimental support in the following examples. The phrases “in another embodiment” or any refence made to embodiment as used herein do not necessarily refer to different embodiment, although it may. Thus, various embodiments of the invention can be combined (from the same or from different aspects) without departing from the scope of the invention.

### NON-LIMITING EXAMPLES

### Example 1: Preparation of a Food Ingredient

The examples below were performed on an aqueous fraction obtained during preparation of a chickpea protein. The process was described in detail in an international patent application publication No. WO2018/122607. In brief, chickpea flour was mixed with water at a temperature of 130° F. and caustic was added to a pH of 8 to 9 in an agitated tank to form a slurry. The slurry was then fed into a centrifuge to separate the insoluble starch-fiber by product (solids) from the protein extract (liquid). The liquid extract was precipitated by adding acid to a pH of 3.5 to 4.5 in an agitated tank at a temperature of 110° Fahrenheit to 140° Fahrenheit for 10 minutes to 60 minutes. The mixture was then fed continuously to a centrifuge.

The liquid fraction is referred herein at times as the legume-derived aqueous fraction.

The aqueous fraction at a temperature of about 23° C.-24° C. was further processed and tested. The pH of the aqueous fraction was determined to be 4.3 and the solid content was 1.5%.

The aqueous fraction was isolated, tested and treated as further detailed below. The product obtained after the treatment is denoted herein as the legume-derived food ingredient and as shown in the examples below acts as a foaming agent.

Samples of the aqueous fraction at pH of 4.3 were heated by induction heating to a temperature of 100° C. for increasing times points. At each time point, about 3 grams were used to measure the % solid content using the moisture analyzer of MRC (IR Moisture Balance). As detailed below, samples with the following solid content of 4%, 6.25%, 10.3%, 11.9%, 24.9%, 29.5%, 36%, 45.5%, 55% and 59% were tested for their foaming capabilities.

In addition, the aqueous fraction was treated with caustic soda solution (NaOH 1M), the amount to be added depend on the sample volume. For example, for 120 g sample with initial pH of 4.3 the amount added was 29.4 g to achieve pH 6.5. Caustic soda was in room temperature. the process was monitored with pH and temperature analyzer. The pH was increased to 5.35, 6.04, 6.44 and 6.5. The aqueous fraction at the increased pH values of 5.35 and 6.5 were heated as noted above and the following samples with solid content were obtained: 37% at pH 5.35; 6.0% at pH 6.04; 12.5% at pH 6.44 and 33.6% at pH 6.5.

The density of each one of the samples was calculated by measuring the volume of a sample in a measuring cup vs. its weight in calibrated analytical balance.

### Example 2: Foaming Properties of the Food Ingredient

### Example 2A: Measurements of Foaming Capacity and Foaming Stability

### Methods

Foam volume was measured for each one of the samples noted above, and foaming capacity was calculated according to the following formula:

$$Foam capacity ( \% ) = \frac{Volume of foam \text{?} - Volume of foam \text{?}}{Volume of foam \text{?}} \times 100 \\ \text{?} \text{indicates text missing or illegible when filed}$$

AW=after whipping; BW=before whipping

Foaming stability was measured as follow: % Foaming Stability=(V_{F30}/V_{F0})*100; V_{F0} is the foam volume immediately after whipping and V_{F30} is foaming volume after 30 minutes.

### Results:

Tables 1A and 1B show the results obtained from the tested sugar faction at various solid content tested at a pH of 4.3, 5.35, 6.04, 6.44 and 6.5 as well as samples of aquafaba and egg white. Foaming capacity is shown in FIG. 1A and foaming stability 30 minutes after whipping is shown in FIG. 1B.

TABLE 1A
characterization of food ingredient at pH 4.3

| Solid | | | | | | | | | | |
|---|---|---|---|---|---|---|---|---|---|---|
| content % | 1.50% | 4% | 6.25% | 10.3% | 11.9% | 24.9% | 29.5% | 36.0% | 45.5% | 55.0% |
| Sample | 1.00 | 1.01 | 1.01 | 1.06 | 1.08 | 1.18 | 1.18 | 1.22 | 1.22 | 1.22 |
| Density | | | | | | | | | | |
| [g/mL] | | | | | | | | | | |
| Initial | 90 | 89 | 90 | 85 | 83 | 76 | 76 | 74 | 74 | 74 |
| volume (mL) | | | | | | | | | | |
| Whipping | 8 | 8 | 8 | 8 | 6 | 3 | 3 | 3 | 3 | 3 |
| time (min) | | | | | | | | | | |
| Foam | No | No | 600 | 600 | 650 | 600 | 700 | 600 | 600 | 350 |
| volume (mL) | stable | stable | | | | | | | | |
| at t = 0 | foam | foam | | | | | | | | |
| Foam | | | 550 | 550 | 640 | 550 | 700 | 600 | 600 | 350 |
| volume (mL) | | | | | | | | | | |
| at t = 15min | | | | | | | | | | |
| Foam | | | 540 | 540 | 600 | 520 | 700 | 580 | 600 | 340 |
| volume (mL) | | | | | | | | | | |
| at t = 30min | | | | | | | | | | |
| Foaming | | | 574 | 606 | 683 | 689 | 82 | 711 | 711 | 373 |
| capacity (%) | | | | | | | | | | |
| Liquid (mL) | | | 60 | 50 | 50 | 30 | very | No | No | No |
| at t = 30min. | | | | | | | little | liquid | liquid | liquid |
| Foaming | | | 92 | 90 | 92 | 87 | 100 | 97 | 100 | 97 |
| stability (%) | | | | | | | | | | |

The physical appearance of the food ingredients comprising between 11.9% and 45% solid content was stiff. The food ingredients comprising 10.3% solid content was soap like with large bubbles.

The results shown in Table 1A indicate that the food ingredient can form foam at a solid content of at least 6% and between about 6.25% to 55%. The food ingredient comprising 59% solid content could not be further processed.

The formed foam was stable for at least 30 minutes after whipping.

TABLE 1B
characterization of food ingredient at pH 5.35, 6.04, 6.44 and 6.5

| | Food ingredient | | | | Aquafaba | Egg white |
|---|---|---|---|---|---|---|
| Solid content % | 6% | 12.5% | 33.6% | 37% | 6% | 12% |
| pH | 6.04 | 6.44 | 6.5 | 5.35 | 5.97 | |
| Liquid Density | 1.01 | 1.05 | 1.14 | 1.15 | 1.01 | 1.02 |
| initial volume (mL) | 89 | 86 | 79 | 78 | 89 | 88 |
| Whipping time | 8 | 6 | 3 | 3 | 8 | 3 |
| (min) | | | | | | |
| Foam volume | No stable | 600 | 700 | 760 | 650 | 800 |
| (mL) at t = 0 | foam | | | | | |
| Foam volume | | 580 | 700 | 760 | 650 | 750 |
| (mL) at t = 15 min | | | | | | |
| Foam volume | | 550 | 700 | 760 | 590 | 750 |
| (mL) at t = 30 min | | | | | | |
| Foaming capacity | | 598 | 786 | 874 | 630 | 809 |
| (%) | | | | | | |
| Liquid (mL) at | | 50 | No liquid | No liquid | 50 | 80 |
| t = 30min. | | | | | | |
| Foaming stability | | 92 | 100 | 100 | 91 | 94 |
| (%) | | | | | | |

The results in Table 1B show that the food ingredient forms a foam also at increased pH values. In addition, the formed foam was stable for at least 30 minutes. By increasing the pH, a foam less dense and more airy was obtained.

Taken together, the results shown in Tables 1A, 1B, FIGS. 1A and 1B suggest that the legume derived food ingredient forms a foam at various % of solid content and at various pH values. Specifically, the foam was stable for at least 30 minutes. In addition, the results show that the legume derived food ingredient had a foaming capacity and foaming stability that were comparable or even better than aquafaba and egg white.

### Example 2B: Characterization of the Foaming Capacity and Stability

### Methods:

Samples of the food ingredient comprising 14.1% solid content, aquafaba and egg white were weighted, and the initial volume was measured. The samples were then whipped for either 3 or 6 minutes at maximum mixing speed (#6) with a whisking hook using a home whipping device.

Table 2 shows the results obtained from the tested samples.

TABLE 2
Foaming capacity and foaming stability of different samples:

| | Mixing | Foaming | Foaming |
|---|---|---|---|
| Sample | time (min) | capacity (%) | stability (%) |
| Foaming agent | 6 | 700.0 | 98.1 |
| Egg white | 3 | 900.0 | 96.8 |
| Aquafaba | 6 | 677.8 | 88.5 |
| Aquafaba | 3 | 250.0 | 40.0 |

The results shown in Table 2 indicate that the foam obtained from the food ingredient of the present disclosure has an improved foaming stability compared to foam obtained from egg whites and from aquafaba.

### Example 2C: Foam Stabilization in Heat Conditions

The foaming agent comprising 14.1% solid content was mixed with corn flour or xanthan-gum and was whipped for 6 minutes as described above. The addition of corn flour or xanthan-gum did not affect the ability of the foaming agent to form a foam. The obtained foam was used to form meringue cookies and was found to be stable at a temperature of about 110° C. for 1 hours (data not shown).

### Example 3: Characterization of the Food Ingredient

### Example 3A: Analysis of Sugar Content

### Methods:

Sugar content of the food ingredient comprising 14.1% solid content was determined using High Performance Liquid Chromatography (HPLC). The sugars (identification and quantification) in the food ingredient were determined vis-à-vis calibration curves that were obtained by plotting peak area versus concentration of each sugar. The results are provided on a dry basis.

### Results:

Table 3A show the sugar distribution in the food ingredient compared with aquafaba.

TABLE 3A
Sugar composition

| | food ingredient (g/100 g; | Aquafaba (g/100 g; |
|---|---|---|
| | % w/w) | % w/w) |
| Total mono and | 10.20 wet based | 8.9 wet based |
| di- saccharides | 11.35 dry based | 9.9 dry based |
| Fructose | 1.70 wet based | 1.00 wet based |
| | 1.89 on dry base | 1.1 dry based |
| Glucose | <0.40 | <0.40 |
| Sucrose | 8.50 wet based | 7.90 wet based |
| | 9.46 dry base | 8.83 dry based |
| Maltose | <0.40 | <1.70 |
| Lactose | Not detected | Not detected |

No significant differences were observed between the food ingredient and aquafaba.

Hence, it was suggested that the improved stability of the food ingredient may not attributed to an increased amount of sugars.

The sugar content of the food ingredient comprising 50% solid content was determined and identified as detailed above.

The results are provided on a dry basis in Table 3B.

TABLE 3B
Sugar composition of mono and disaccharides

| | Food Ingredient (g/100 g; % w/w) |
|---|---|
| Total mono and di- saccharides | 12.9 |
| Fructose | 5.40 |
| Glucose | 1.90 |
| Sucrose | 5.60 |
| Maltose | Not detected |
| Lactose | Not detected |

As can be seen a similar amount of mono and di-saccharides was observed in the two tested food ingredients. The slight differecne between the amount of mono and di-saccharides may be due to hydrolysis of the di-saccharides.

The oligosaccharides content of the food ingredient comprising 39.8% solid content. The results are provided on a dry basis in Table 3C.

TABLE 3C
Sugar composition of oligosaccharides

| | food ingredient (g/100 g; % w/w) |
|---|---|
| Raffinose | 1 |
| Stachyose | 4.7 |
| Verbacose | 0.3 |

### Example 3B: Protein Molecular Weight/Mass (MW) Determination by SDS PAGE Electrophoresis

### Methods:

### SDS-PAGE Electrophoresis

The food ingredient comprising 14.1% solid content was dissolved to a solution of 10 mg powder/ml, equivalent to 2.1 mg protein/ml and this solution was used as stock solution, which before loading on the gel was diluted by 5, 7, 8.5 and 10. Aquafaba was diluted to 2.1 mg protein/ml and this solution was used as stock solution, which before loading on the gel was diluted by 5, 7, 8.5 and 10. SDS-PAGE experiments were repeated twice at different times.

Protein molecular weight determination of the food ingredient and aquafaba obtained from canned chickpea (Pri-Galil, Israel) was performed via sodium dodecyl sulfate polyacrylamide gel electrophoresis (SDS-PAGE). Gels (4-20% Mini-PROTEAN®TGX™ Gel, 10 well, 50 μl #4561094, BioRad) were loaded with 45 μl protein samples, or 10 μl size marker.

Electrophoresis was performed at 180 V for 25 minutes in a Tris/Glycine/SDS running buffer. Gels were fixed in 30% ethanol, 10% acetic acid and 60% DW, rinsed in DW and stained with Coomassie Brilliant Blue R-250, washed with 30% ethanol, 15% acetic acid and 55% DW for one hour and then immersed in 10% acetic acid, 90% DW until imaging. All other chemicals used for SDS-PAGE analysis were from Bio-Rad Laboratories (Rishon LeZion, Israel).

### Analysis of SDS-PAGE

Quantitative analysis was performed on the bands from the samples which were diluted to 0.3 mg protein/ml before loading into the gel and correspond to lanes AFx7 and SF x7.

The background subtraction (baseline correction) of the gel was performed by application of the “rolling ball” algorithm, prior to image analysis.

Each “band” was measured, and the % stain intensity was calculated as the percent of the band's stain intensity, where 100% is the sum of stain intensity of all quantifiable bands in a specific running lane. As the mass of protein loaded in each gel lane was similar, the sample AFx7 is directly comparable to sample SFx7, etc.

### Results:

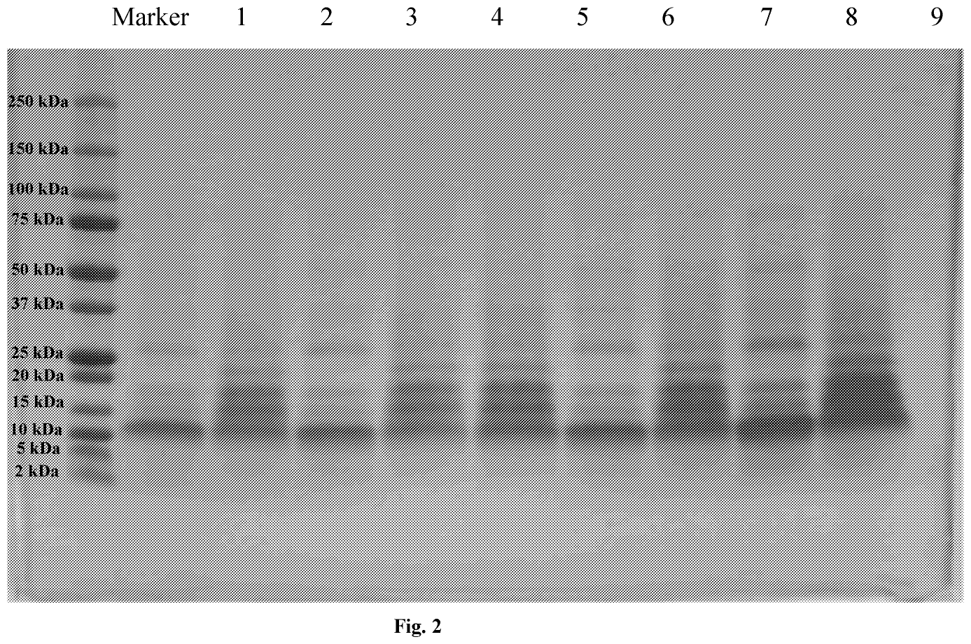

SDS-PAGE was used to determine the MW of protein subunits in the aqueous solution. FIG. 2 show a representative SDS-PAGE of the food ingredient comprising 14.1% solid content (“SF”) compared with aquafaba (“AF”) at various dilutions as described above (5, 7, 8.5 and 10) and indicated above.

Quantitative analysis of the SDS-PAGE showing the MW of identified chickpea subunits of the food ingredient and chickpea aquafaba in provided in Table 4.

The SDS-PAGE patterns of the food ingredient were characterized by a main population of proteins with MW in the range 8-25 kDa, with a major band at about 12 kDa. Interestingly, while the aquafaba sample also have a band at 12 kDa, the band intensity in the foaming agent was almost double than the corresponding band in the aquafaba sample. This result suggests that there is an increased protein population with a molecular weight of 12 kDa in the aqueous solution.

In addition, the band at about 16-17 kDa was significantly reduced in the food ingredient compared with aquafaba, suggesting a decreased protein population with a molecular weight of 16-17 kDa in the aqueous solution.

TABLE 4
Molecular weights of chickpea protein as estimated by SDS-PAGE

| | Foaming agent, | Aquafaba, |
|---|---|---|
| MW [kDa] | % stain intensity | % stain intensity |
| 8 | 1.4 | |
| 12 | 70.8, 72.8 | 45.4, 44.8 |
| 14 | 3.4, 8.7 | 11.8, 13.7 |
| 16-17 | 7, 4, 3.9 | 18.6, 19.2 |
| 19 | | 14.1 |
| 21-22 | 10.5 | 10.4 |
| 23 | | 7.8 |
| 25 | 11.5 | 7.6 |
| 27 | 0.9 | |
| 29 | | 0.4 |
| 31 | 1.6 | |
| 35 | 2.0 | 6.1 |
| 50 | 1.9 | |
| 79 | 1.7 | |
| 83 | 1.7 | |

The results suggested that the food ingredient of the present invention has a different protein composition as compared with aquafaba. This may account, at least in part, to the improved foaming stability of the food ingredient compared with aquafaba.

### Example 3C: Starch Analysis

### Methods:

Starch concentrations in the food ingredient comprising 14.1% and 50% solid content and in an aquafaba sample was determined using the polarimetric method.

### Results:

Data from two independent measurements showed that the food ingredient comprising 14.1% solid content includes very low amounts of starch, lower than 0.1% (w/w). Similarly, no starch was detected in the food ingredient comprising about 50% solid content.

The amount of starch in an aquafaba sample was significantly higher and was found to be 0.83% (w/w). The results show that the aqueous solution, unlike aquafaba, is almost essentially free from starch.

Interestingly, despite the low amounts of starch, the food ingredient was shown to produce stable foam that is as good as the foam obtained from egg whites and better than foam obtained from aquafaba.

### Example 3D: Protein Analysis

### Methods:

Protein concentrations in the food ingredient comprising 14.1% and 50% solid content a was determined using a combustion method.

### Results:

The results showed that the food ingredient comprising between about 23% and abut 30% protein out of the total weight of the food ingredient on dry basis.

1. A legume-derived food ingredient, the food ingredient comprising sugar, legume starch and legume proteins,
wherein said food ingredient includes at most 0.8% legume starch; and
wherein said food ingredient is characterized by a solid content of at most 60%.

2. (canceled)

3. The legume-derived food ingredient of claim 1, characterized by a solid content of between about 6% and about 55% optionally by a solid content of between about 10% and about 55%, optionally by a solid content of between about 29% and about 55%.

4. (canceled)

5. (canceled)

6. The legume-derived food ingredient of claim 1 comprising at most 0.5% legume starch.

7. The legume-derived food ingredient of claim 1, comprising at least 8% sugar.

8. The legume-derived food ingredient of claim 1, wherein said sugar comprises a combination of sugars.

9. The legume-derived food ingredient of claim 8, wherein said combination of sugars comprises at least one of fructose, glucose, maltose and sucrose.

10. The legume-derived food ingredient of claim 1, comprising at least 20% proteins on dry basis.

11. The legume-derived food ingredient of claim 1, comprising between about 20% and about 40% legume proteins on dry basis.

12. The legume-derived food ingredient of claim 1, wherein at least about 46% of the legume proteins on dry basis have a molecular weight of about 12 kDa as determined by SDS-PAGE

13. The legume-derived food ingredient of claim 1, wherein the legume starch and legume protein are both derived from said legume.

14. The legume-derived food ingredient of claim 13, wherein said legume is selected from the group consisting of chickpeas, alfalfa, clover, beans, peas, lentils, lupins, mesquite, carob, soybeans, peanuts, and tamarind.

15. The legume-derived food ingredient of claim 14, wherein the legume is chickpea.

16. The legume-derived food ingredient of claim 1, being characterized by
(i) a foaming capacity of at least 350% after a mixing time of 6-8 minutes at maximum mixing speed using a home whipping device and/or
(ii) a foaming stability of at least 85% 30 minutes after a mixing time of 6-8 minutes at maximum mixing speed using a home whipping device.

17. (canceled)

18. (canceled)

19. An egg replacer or foaming agent comprising the legume-derived food ingredient of claim 1.

20. (canceled)

21. (canceled)

22. A process comprising:
mixing legume flour with a basic pH adjusting agent to obtain a basic slurry with a basic pH;
isolating a first liquid fraction from said basic slurry;
treating the first liquid fraction with an acidic pH adjusting agent to obtain an acidic slurry;
isolating a second liquid fraction from said acidic slurry to obtain a legume derived aqueous fraction; and
treating said second liquid fraction by concentrating, optionally by heating.

23. The process of claim 22 wherein said mixing is at a temperature of about 55° C.

24. (canceled)

25. The process of claim 22, wherein said isolating the first liquid fraction and the second liquid fraction is by centrifugation.

26. The process of claim 22, wherein said treating the first liquid fraction is at a temperature of between about 30° C. and about 55° C.

27. (canceled)

28. (canceled)

29. A food product comprising the legume derived food ingredient of claim 1, optionally wherein the legume derived food ingredient is in foamed form.

30. (canceled)

31. The food product of claim 29, being a (i) non-baked food product or (ii) bakery or a pastry food product.

32. (canceled)
